(19) United States
(12) Patent Application Publication
(10) Pub. No.: US 2026/0138270 A1
(43) Pub. Date: May 21, 2026

(54) ROBOT CONTROL METHOD, ROBOT, AND COMPUTER-READABLE STORAGE MEDIUM

(71) Applicant: UBTECH ROBOTICS CORP LTD., Shenzhen (CN)

(72) Inventors: PENGPENG XU, Shenzhen (CN); Huaxi Zhang, Shenzhen (CN); Meng Yan, Shenzhen (CN); Wenlong Qin, Shenzhen (CN); Ligang Ge, Shenzhen (CN)

(21) Appl. No.: 19/342,546

(22) Filed: Sep. 27, 2025

(30) Foreign Application Priority Data
Nov. 15, 2024 (CN) 202411640229.1

(51) Int. Cl. B25J 9/16; B25J 13/08

(52) U.S. Cl. CPC B25J 9/163; B25J 9/1697; B25J 13/085; B25J 13/088

(57) ABSTRACT

A robot control method, a robot, and a computer-readable storage medium. The method includes obtaining a first joint state of a robotic arm of a robot at a first moment, and an environmental image collected by the robot at the first moment for a current environment; determining a first joint feature between the environmental image and the first joint state, and obtaining a second joint state by predicting a joint state of the robotic arm at a second moment based on the first joint feature; determining an adversarial feedback detail, and obtaining a third joint state by adjusting the second joint state based on the adversarial feedback detail; and controlling the robotic arm to swing to the third joint state in response to being at the second moment. In this manner, the control accuracy of the robot can be improved.

### CROSS REFERENCE TO RELATED APPLICATIONS

The present disclosure claims priority to Chinese Patent Application No. 202411640229.1, filed Nov. 15, 2024, which is hereby incorporated by reference herein as if set forth in its entirety.

### TECHNICAL FIELD

The present disclosure relates to robotics technology, and particularly to a robot control method, a robot, and a computer-readable storage medium.

### BACKGROUND

With the rapid development of robotic technology, visually-guided motion control has been widely used in robotic automation control systems. In particular, the control system that provides visual inputs using a camera can realize the autonomous perception and environment interaction of a robot. However, a traditional visual motion control method usually requires a large number of tests and adjustments in specific environments, and the precision of the control of the robotic arm is poor when dealing with new scenarios due to the computing power of controller and the generalization of algorithm are limited.

### BRIEF DESCRIPTION OF DRAWINGS

FIG. 1 is a schematic diagram of the structure of a robot control system according to an embodiment of the present disclosure.

FIG. 2 is a schematic diagram of the structure of an electronic device according to an embodiment of the present disclosure.

FIG. 3A is a flow chart of a robot control method according to an embodiment of the present disclosure.

FIG. 3B is a flow chart of determining a first joint feature according to an embodiment of the present disclosure.

FIG. 3C is a flow chart of determining a third joint state according to an embodiment of the present disclosure.

FIG. 3D is a flow chart of determining an adversarial feedback detail according to an embodiment of the present disclosure.

FIG. 4 is a schematic diagram of a robot according to an embodiment of the present disclosure.

FIG. 5 is a schematic diagram of the structure of a robot control model according to an embodiment of the present disclosure.

### DETAILED DESCRIPTION

In order to make the objects of the present disclosure clearer, the technical solutions and advantages will be described in addition with reference to the drawings. The described embodiments will be described in detail below with reference to the present disclosure. All other embodiments obtained by those skilled in the art without creative work are within the scope of the present disclosure.

In the following descriptions, “some embodiments” are involved, which describe a subset of all possible embodiments. It should be noted that “some embodiments” may refer to the same subset or different subset of all possible embodiments, which can be combined with each other when there is no conflict.

In the following descriptions, the involved terms “first”, “second”, “third”, and the like are merely for differentiating similar objects and do not represent a specific order for the objects. It should be noted that the specific order or sequence of “first”, “second”, “third”, and the like may be interchanged under certain conditions so that the embodiments of the present disclosure described herein may be implemented in an order other than those illustrated or described herein.

In the embodiments of the present disclosure, the term “module” or “unit” refers to a computer program or part of a computer program with preset functions and works with other related parts to achieve predetermined goals and may be implemented by using software, hardware (e.g., processing circuit or storage) or a combination thereof in whole or in part. Likewise, a processor (or a plurality of processors or storages) may be used to implement one or more modules or units. In addition, each module or unit may be part of an integral module or unit containing the function of the module or unit.

Unless otherwise defined, all technical and scientific terms used in the embodiments of the present disclosure have the same meaning as commonly understood by those skilled in the art. The terms used in the embodiments of the present disclosure are merely for describing the embodiments of the present disclosure rather than limiting them.

In the embodiments of the present disclosure, the relevant data collection and processing should be strictly based on the requirements of relevant laws and regulations and obtain the informed consent or separate consent of the subject of personal information, and should carry out subsequent data use and process within the scope of the authorization of laws, regulations, and the subject of personal information.

Before further detailed description of the embodiments of the present disclosure, the involved nouns and terms will be described as follows.

1) Latent space refers to a potential representation of data learned through encoder. The latent space is a mapping of high-dimensional data in low-dimensional space. It captures the essential characteristics of the data, so that the data can be represented and operated effectively in low-dimensional space. The latent space provides a low-dimensional representation of the data, which helps to reduce the complexity of the data so that the data easier to process. Each point in the latent space corresponds to a latent variable of the data, which is usually assumed to follow a certain probability distribution such as Gaussian distribution. The latent space is usually continuous, which means that the data points close to each other are also close to each other in the latent space, and therefore can facilitate the generation of continuous data samples.

2) Original space refers to the space where the input data exists in the VAE. The space contains all possible input data points, which are used to learn the parameters of the encoder and decoder during training.

In the embodiments of the present disclosure, a robot control method, an electronic device, and a computer-readable storage medium are provided, which can improve the control accuracy of a robot.

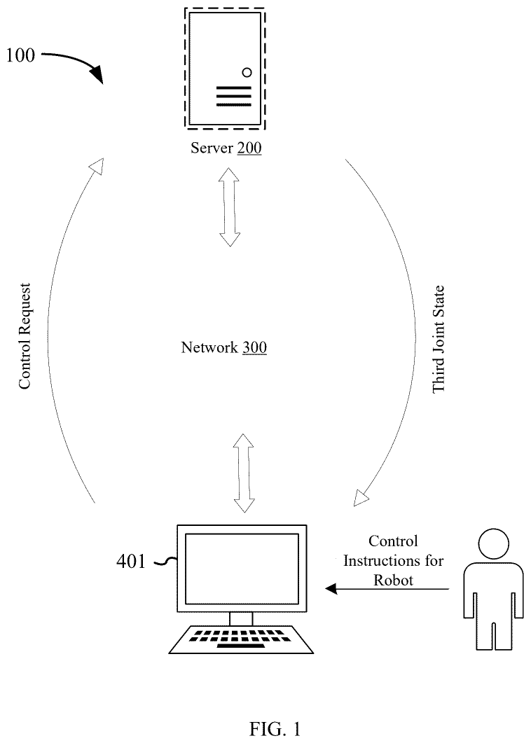

FIG. 1 is a schematic diagram of the structure of a robot control system 100 according to an embodiment of the present disclosure. As shown in FIG. 1, in order to support a robot control application, a terminal 401 connects to a server 200 through a network 300. The network 300 may be a wide area network or a local area network, or a combination of the two. In which, the terminal 401 may be a terminal installed on the robot, or a termina communicating with the robot in real time.

The terminal 401 is configured to transmit a robot control request to the server 200 in response to control instructions for the robot. The server 200 is configured to obtain a first joint state of a robotic arm of the robot at a first moment, and an environmental image collected by the robot at the first moment for a current environment, determine a first joint feature between the environmental image and the first joint state and obtain a second joint state by predicting a joint state of the robotic arm at a second moment based on the first joint feature, and determine an adversarial feedback detail and obtain a third joint state by adjusting the second joint state based on the adversarial feedback detail. The server 200 may transmit the third joint state to the terminal 401 to control the robotic arm to swing to the third joint state in response to being at the second moment.

In some embodiments, the server 200 may directly transmit the third joint state to the terminal 401 in response to receiving the robot control request. The terminal 401 may also actively obtain the third joint state from the server 200.

In some embodiments, the terminal 401 may be various types of terminal like a robot terminal, a laptop, a tablet, a desktop computer, a set-top box, a smartphone, a smart speaker, a smart watch, a smart TV, a car terminal, or be a server.

In some embodiments, the server 200 may be a stand-alone physical server, or a server cluster or distributed system composed of multiple physical servers, or may also be a cloud server providing cloud service, cloud database, cloud computing, cloud function, cloud storage, network service, cloud communication, middleware service, domain name service, security service, content delivery network (CDN), and basic cloud computing service such as big data and artificial intelligence platform. The terminal 200 and the electronic device 400 may be connected directly or indirectly through wired or wireless communication.

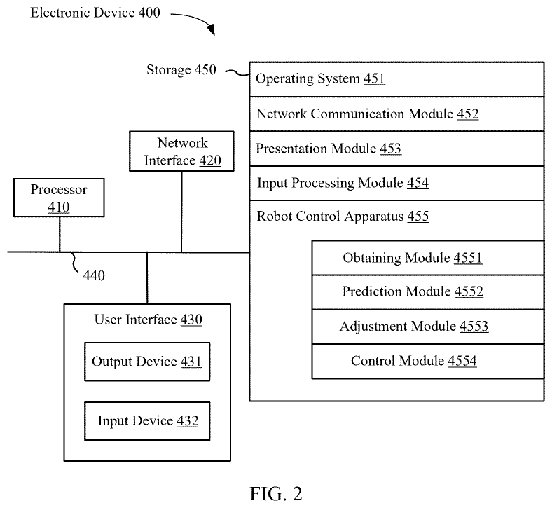

FIG. 2 is a schematic diagram of the structure of an electronic device 400 according to an embodiment of the present disclosure. As shown in FIG. 2, the electronic device 400 may include at least one processor 410, a storage 450, at least one network interface 420, and a user interface 430, where the foregoing components of the electronic device 400 are coupled together through a bus system 440 that is for realizing connection communication between the components. The bus system 440 may include, in addition to a data bus, a power bus, a control bus, and a status signal bus. Though, for clarity, the various buses are merely marked as the bus system 440 in FIG. 2.

The processor 410 may be an integrated circuit chip with signal processing capabilities, which may be, for example, a general-purpose processor, a digital signal processor (DSP), or other programmable logic device, discrete gate or transistor logic device, discrete hardware component, or the like. In which, the general-purpose processor may be a microprocessor, any conventional processor, or the like.

The user interface 430 may include one or more output devices 431 for presenting media contents, which may include one or more speakers and/or one or more visual displays. The user interface 430 may further include one or more input devices 432, which may include user interface component that facilitate user input, such as keyboard, mouse, microphone, touch screen display, camera, other input button and control.

The storage 450 may be removable, non-removable, or a combination thereof. For example, the storage 450 may include solid state memory, hard disk drive, optical disk drive, or the like. The storage 450 may optionally include one or more storage devices physically located away from the processor 410.

The storage 450 may include volatile memory, nonvolatile memory, or both. The nonvolatile memory may be read-only memory (ROM), and the volatile memory may be random access memory (RAM). In this embodiment, the storage 450 is intended to include any suitable type of storages.

In some embodiments, the storage 450 is able to store data to support various operations. The data may include, for example, programs, modules, data structures, or subsets or supersets thereof, as described below.

An operating system 451 including system programs for processing various basic system services and performing hardware-related tasks, such as framework layer, core library layer, and driver layer that are for realizing various basic services and processing hardware-based tasks.

A network communication module 452 configured to reach other electronic devices via the (wired or wireless) network interfaces 420. For example, the network interface 420 may include Bluetooth, wireless compatibility authentication (Wi-Fi), universal serial bus (USB), and the like.

A presentation module 453 configured to present information through one or more output devices 431 (e.g., display screen and speaker) associated with the user interface 430, for example, a user interface for operating peripherals and displaying content and information.

An input processing module 454 configured to detect and translate user inputs or interactions from the one or more input devices 432.

In some embodiments, the apparatus provided by the embodiments of the present disclosure may be implemented in software. As shown in FIG. 2, there is a robot control apparatus 455 stored in the storage 450, which may be a software in the form of program, plug-in, or the like that may include software modules namely an obtaining module 4551, a prediction module 4552, an adjustment module 4553, and a control module 4554. These modules are logical, so any combination or further disassembly may be performed according to the functions to be implemented. The functions of each module will be described below.

In other embodiments, the apparatus provided by the embodiments of the present disclosure may be implemented in hardware, and as an example, the apparatus may be a processor in the form of a hardware decoding processor that is programmed to execute the anomaly detection method provided by the embodiments of the present disclosure. For example, the hardware decoding processor may adopt one or more application specific integrated circuits (ASICs), DSPs, programmable logic devices (PLDs), complex programmable logic devices (CPLDs), field-programmable gate arrays (FPGAs), or other electronic components.

Below, the robot control method provided by the embodiments of the present disclosure will be described with reference to the drawings. In this embodiment, the electronic device for implementing the robot control method may be a terminal 401, a server 200, or a combination of the two. Therefore, the subject to execute each step will not be described again below.

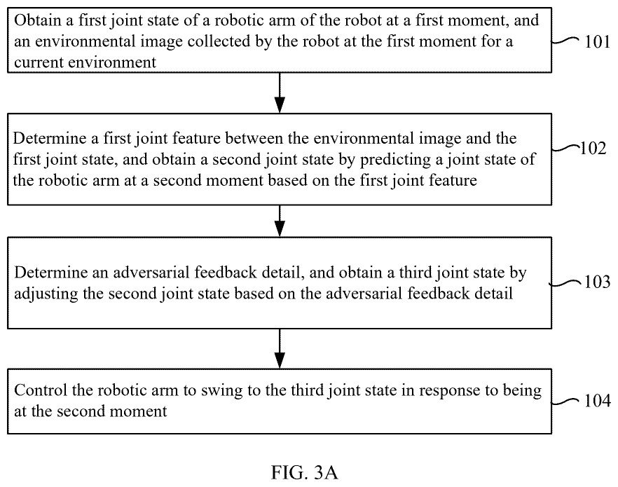

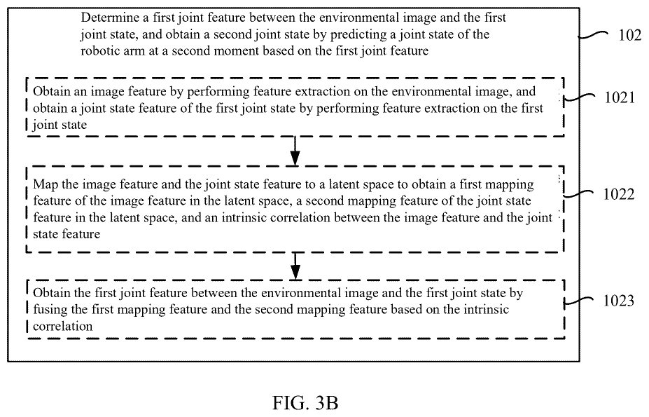

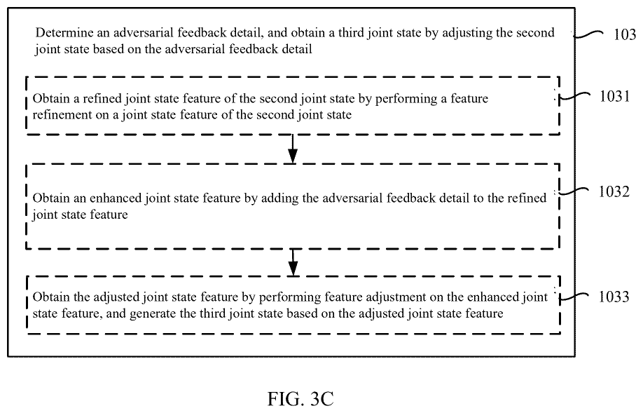

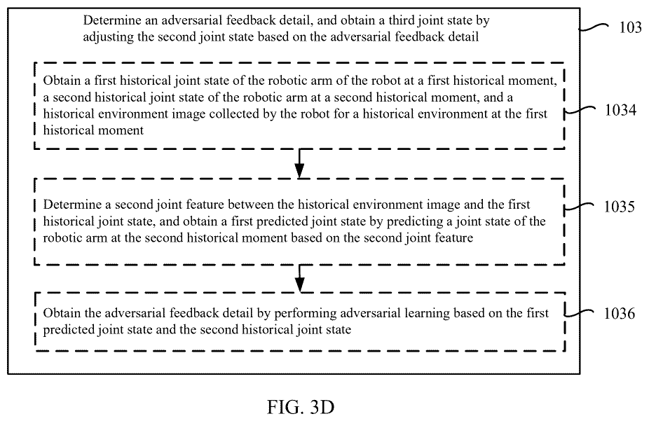

FIG. 3A is a flow chart of a robot control method according to an embodiment of the present disclosure. As shown in FIG. 3A, in this embodiment, the robot control method will be explained by taking the terminal 401 as the subject as an example.

101: obtaining a first joint state of a robotic arm of the robot at a first moment, and an environmental image collected by the robot at the first moment for a current environment.

In this embodiment, the robot has a moveable robotic arm. The type of the robot may be an industrial robot for carrying out industrial tasks such as handling, assembly, packaging, welding, and sorting through the robotic arm. The type of the robot may also be a service robot for medical assistance (e.g., surgical assistance or rehabilitation assistance), household tasks (e.g., cleaning or nursing), catering services (e.g., food preparation or food delivery), or be any other robot that has robotic arm such as a detection robot, a rescue robot, and a bionic robot. It should be noted that different types of robotic arms are designed to have different degrees of freedom, from the simplest two degrees of freedom to highly complex seven or more degrees of freedom that can enable the robot to perform simple repetitive tasks or highly complex and precise operations.

The robot can also install with a camera or other visual sensor to capture visual information in the surrounding environment (e.g., obtaining visual information from images). The robot can identify and perceive specific objects, landmarks, obstacles and other information in the environment by analyzing the collected images.

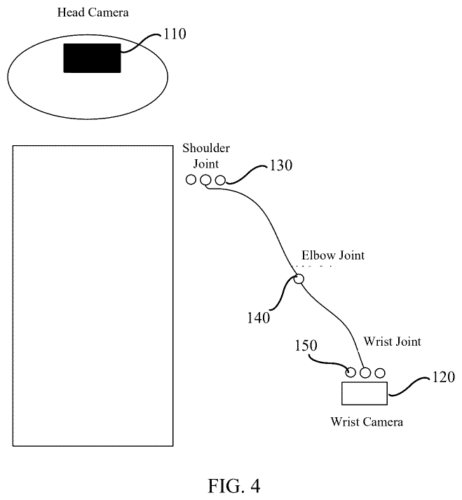

FIG. 4 is a schematic diagram of a robot according to an embodiment of the present disclosure. As shown in FIG. 4, in this embodiment, taking a sorting robot as an example, the sorting robot may include a head camera 110 and a wrist camera 120. The head camera 110 and wrist camera 120 may collect environmental images in the current environment in which the robot is located. The robotic arm of the robot has a shoulder joint 130, an elbow joint 140 and a wrist joint 150 that are movable. The sorting robot can control the robotic arm to perform the tasks of sorting items by controlling the position of each joint.

Each joint point of the robot is installed with a sensor (e.g., a position sensor, a velocity sensor, a force sensor, and an accelerometer), where the robot can collect the joint state of each joint of the robotic arm.

In which, the joint state of the robot refers to the movement state and position information of the joint of the robotic arm at a specific moment. As an example, the joint state may include the following information: the specific position of the joint in space such as angle (for rotation joints) or linear displacement (for straight joints), the speed for describing the speed of joint movement that usually represents as angle/s (for rotation joints) or mm/s (for straight joints), the acceleration representing the speed of joint velocity changes which is usually described as angle/s² or mm/s², the force or moment reflecting the magnitude of the force or torque applied or received by the joint, the joint angle for rotation joint that is the rotational angle of the joint axis relative to the reference position such as the absolute rotational angle of the motor controlling the rotation of the joint, the joint displacement for linear joint that is the displacement of the joint along its axis, the joint posture describing the posture of the joint relative to the reference position that includes a combination of angle and displacement, electrical parameters including motor current, voltage and other information that may be for monitoring the working state of the motor, and encoder reading that is positional feedback provided by the encoder for accurately controlling the joint position.

In this embodiment, to control the robot to perform tasks, it may obtain the first joint state of the robotic arm of the robot at the first moment, and may obtain the environmental image collected by the camera of the robot for the current environment at the first moment. In which, the first moment may be understood as the current moment; the first joint state may include joint state information of one or more joints of the robotic arm, and the first joint state may include at least position information of joint such as joint angle and joint displacement, the environmental image is an image of the direction at which the camera of the robot faces, for example, the image collected by the head camera of the sorting robot that includes the objects to be sorted in the direction of the head camera.

In this embodiment, a trained robot control model may be installed in the terminal 401 of the robot. By inputting the environmental image collected by the camera of the robot and the first joint state collected by the sensor of the robot into the robot control model, the third joint state for controlling the movement of the robotic arm can be determined through the robot control model using the robot control method, thereby realizing the control of the robotic arm.

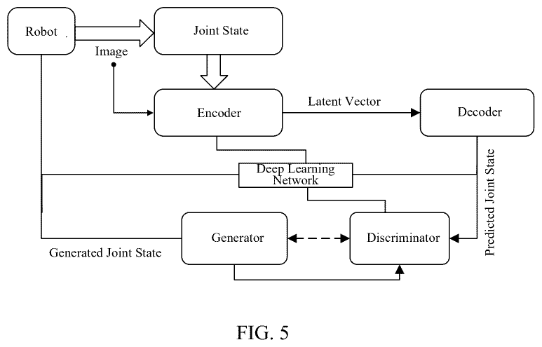

FIG. 5 is a schematic diagram of the structure of a robot control model according to an embodiment of the present disclosure. As shown in FIG. 5, the robot control model may be composed of a variational autoencoder (VAE) and a generative adversarial network (GAN). In which, the VAE includes an encoder and a decoder, and the GAN s includes a generator and a discriminator.

As an example, it may construct a model architecture of the robot control model using the VAE and the GAN, and construct the encoder and the decoder in the VAE as well as the generator and the discriminator in the GAN based on a deep learning network such as a Transformer network structure.

FIG. 3A is a flow chart of a robot control method according to an embodiment of the present disclosure. As shown in FIG. 3A, the steps after step 101 are continued to explain.

102: determining a first joint feature between the environmental image and the first joint state, and obtaining a second joint state by predicting a joint state of the robotic arm at a second moment based on the first joint feature.

Here, the second moment is later than the first moment, the first moment is the current moment, and the second moment is the next moment later than the current moment that is determined based on the control frequency of the robotic arm. Taking the robot works at the control frequency of once a second as an example, if the first moment is the current moment of 12-th second at a certain minute of a certain hour, the second moment may be 13-th second at a certain minute of a certain hour.

FIG. 3B is a flow chart of determining a first joint feature according to an embodiment of the present disclosure. As shown in FIG. 3B and the robot control model shown in FIG. 5, step 102 may include 1021-1023.

1021: obtaining an image feature by performing feature extraction on the environmental image, and obtaining a joint state feature of the first joint state by performing feature extraction on the first joint state.

In this embodiment, after obtaining the environmental image and the first joint state at the first moment, it may use the environmental image and the first joint state as the inputs of the encoder in the VAE, and perform feature extraction on the environmental image and the first joint state through the encoder.

As an example, after the encoder of the VAE receives the environmental image as the input, it may extract the features of the environmental image through a series of convolutional layers constructed based on the Transformer network. These convolutional layers may capture the local feature and spatial hierarchy structure in the environmental image. The image feature may include visual features, and the basic visual features in the environmental image like texture, color, shape, and edge will be extracted by the encoder. These visual features can help the encoder to understand the object, scene and background in the image. The image feature may also include spatial relationships between the objects in the environmental image such as position, direction, and distance that may help the robot control model to understand the overall layout of the environmental image. The image feature may further include context information in the environmental image such as the interaction between the object and the surrounding environment. If there is an object of robotic arm in an environmental image, the encoder will notice the relationship between the object of robotic arm and the surrounding tools or objects. The image feature may still further include dynamic information. If the environmental image is a sequence and the sequence is continuous, the encoder will extract dynamic changes between the environmental images such as the motion trajectory of the robotic arm or the positional changes of the objects. The image feature may, again, include semantic information in the environmental image such as the category, behavior and events of the objects, which will also be extracted by the encoder, especially if those related to the task performed by the robotic arm.

As an example, after receiving the first joint state as the input, the encoder of the VAE may extract the joint state feature in the first joint state through a series of fully connected layers or recurrent layers constructed through the Transformer network. When the encoder performs the feature extraction on the first joint state, it usually focuses on key information that can reflect the motion and behavior of the joint like position information which enables the robot control model to better understand the current state of the robotic arm and predict the future behavior. The joint state feature may include position feature such as joint angle and joint displacement, where for a rotation joint, the joint angle is the angle of a joint relative to a reference position or an absolute rotational angle of the motor controlling the joint, and for a linear joint, the joint displacement is the displacement of the joint along its axis. The joint state feature may also include velocity feature such as angular velocity and linear velocity, where for a rotation joint, the angular velocity is the magnitude of the joint angular velocity, and for a linear joint, the linear velocity is the velocity of the joint displacement. The joint state feature may further include acceleration feature such as angular acceleration and linear acceleration, where for a rotation joint, the angular acceleration is the magnitude of the joint angular acceleration, and for a linear joint, the linear acceleration is the acceleration of the joint displacement. The joint state feature may still further include force or moment feature, such as joint force and joint moment, where the joint force reflects the magnitude of the force applied by the joint, and the joint moment reflects the magnitude of the torque applied by the joint. The joint state feature may, again, include dynamic feature, such as motion smoothness and motion stability, where the motion smoothness can reflect whether the joint movement is stable which may be measured by the change rate of acceleration, while the motion stability can reflect whether the joint movement remains on the expected trajectory. The joint state feature may, once more, include time feature like the periodic feature of the joint movement, for example, swing motion period or time series feature. During the feature extraction, there are also some derived features to be considered, for example, the features obtained through differential and integral operations, as well as the features obtained through statistical analysis (e.g., mean, standard deviation, or variance). The foregoing features may be used in a variety of control strategies including model prediction control, feedback control, adaptive control, and intelligent control (e.g., deep learning or reinforcement learning), and which joint state features is selected depends on the specific control task, the design of the robotic arm, and the required control accuracy. Usually, the feature selection is an iterative process that needs to be adjusted and optimized according to the control effect.

1022: mapping the image feature and the joint state feature to a latent space to obtain a first mapping feature of the image feature in the latent space, a second mapping feature of the joint state feature in the latent space, and an intrinsic correlation between the image feature and the joint state feature.

In this embodiment, after receiving the environmental image and the first joint state, the encoder of the VAE will perform the feature extraction on the environmental image and the first joint state, respectively, through step 1021 to obtain the joint state features with the format compatible with the image feature so that, for example, both features are feature vectors of the same dimension or matrices of a fixed size. Then, the joint state feature and image features after integrating the format will be transmitted to different neural network layers of the encoder to perform feature mapping on the image feature and the joint state feature.

In which, the latent space refers to the potential representation of the data learned by the encoder of the VAE. The latent space is a mapping of high-dimensional data in a low-dimensional space, which may capture the essential features of the data, so that the data can be represented and operated effectively in the low-dimensional space. Specifically, the latent space provides a low-dimensional representation of the data, which can reduce the complexity of the data and make the data easier to process. Each point in the latent space corresponds to a potential variable of the data. These variables are assumed to follow certain probability distributions, and the latent space is usually continuous, which means that the originally close points will be also close in the latent space, thereby fascinating the generation of continuous data.

In this embodiment, in order to obtain the correlation information from the environmental image and the first joint state and capture significant and useful information in the two types of data, the neural network layer of the encoder may map the image feature and the joint state feature to the latent space to obtain the first mapping feature of the image feature in the latent space and the second mapping feature of the joint state feature in the latent space. The intrinsic correlation between the image feature and the joint state feature is obtained through the representation of the first mapping feature in the latent space and that of the second mapping feature in the latent space.

In which, the intrinsic correlation may include: spatial correspondence that is the correspondence between the spatial position in the environmental image and the first joint state, for example, a specific area in the environmental image may correspond to a specific joint motion of the robotic arm; a timing correspondence of the environmental image and the first joint state that can be extracted by the encoder if the input data contains time series information, for example, the change of the first joint state may indicate the imminent change of certain features in the environmental image; a motion trajectory correspondence between the motion trajectory of the robotic arm and that of the object in the image which can be extracted by the encoder; a posture and viewing angle correspondence about how the posture changes of the robotic arm affects the viewing angle of the camera and how such changes are reflected in the environmental image which can be extracted by the encoder; and a feature mapping correspondence that can be realized through the encoder by mapping the features in the environmental image to the adjustment of the first joint state so as to achieve a specific goal of task.

Through the foregoing method, by learning the data distributions of the environmental image and the first joint state in the latent space through the VAE of the robot control model, the model can be better generalized to new data, thereby improving the generalization ability of the model.

1023: obtaining the first joint feature between the environmental image and the first joint state by fusing the first mapping feature and the second mapping feature based on the intrinsic correlation.

In this embodiment, the encoder of the VAE may combine the first map feature and the second map feature based on the intrinsic correlation through a shared layer or a specific fusion layer to output a latent vector that is a low-dimensional representation representing the intrinsic correlation between the environmental image and the first joint state in the latent space. The latent vector may contain joint information of the environmental image and a first key state. In which, the latent vector is the first joint feature that is the comprehensive representation of both the environmental image and the first joint state that is obtained by the encoder. Through feature fusion, the robot control model can understand the interaction between the environmental image and the first joint state based on the first joint feature.

Through the foregoing method, the robot control model can learn the correlation between the visual features of the environmental image and the first joint state through the feature processing performed on the environmental image and the first joint state by the encoder of the VAE. For example, in a sorting task of the robot, the direct relationship between the position of the objects in the environmental image and the joints of the robotic arm is obtained, and the encoder can reveal the dependence of certain features in the environmental image on the first joint state like the movement of a certain joint of the robotic arm causing a change in the viewing angle of the camera to affect the input of the environmental image. The encoder may also enable the robot control model to learn synergistical changes of the environmental image and the first joint state through the first joint feature.

The foregoing step 102 is continued to explain.

In some embodiments, in step 102, “obtaining a second joint state by predicting a joint state of the robotic arm at a second moment based on the first joint feature” may include: obtaining a third mapping feature of the first joint feature in an original space where the first joint state is located by mapping the first joint feature from the latent space to the original space; and obtaining the second joint state by predicting the joint state of the robotic arm at the second moment based on the third mapping feature.

In this embodiment, the decoder of the VAE is configured to map the features in the latent space back to the original space to generate the data similar to the original input.

In which, the original space refers to the space in which the input data (i.e., the first joint state) of the VAE locates. The original space contains all possible input data points, which is defined by the dimension of the input data. The data type in the original space depends on the type of the input data. The data points in the original space are distributed with a certain manner that is usually unknown. One of the goals of the VAE is to approximate this distribution by learning. The data in the original space is usually represented as a high-dimensional vector which contains all the features of the data.

In this embodiment, the decoder receives the first joint feature from the latent space of the encoder, maps the feature of the first joint feature in the latent space back to the original space where the first joint state is located, that is, converting the representation (i.e., the first joint feature) of the latent space into the feature (i.e., the third mapping feature) with the same dimension as the original data (i.e., the joint state feature of the first joint state). This mapping may be realized through a fully connected layer or a convolutional layer. Then, the joint state of the robotic arm at the second moment is predicted through the third mapping feature to obtain the second joint state.

In which, the second joint state is the result of the initial prediction made by the VAE for the position of the robotic arm of the robot at the second moment.

As shown in FIG. 3A, the foregoing step 102 is continued to explain.

103: determining an adversarial feedback detail, and obtaining a third joint state by adjusting the second joint state based on the adversarial feedback detail.

In this embodiment, the generator of the GAN may generate, based on the adversarial feedback detail, a more refined joint state using the second joint state output by the VAE to obtain the third joint state. In which, the adversarial feedback detail is from the data distribution learned by the generator or the feedback obtained from the discriminator during training the robot control model.

FIG. 3C is a flow chart of determining a third joint state according to an embodiment of the present disclosure. As shown in FIG. 3C, in some embodiments, “obtaining a third joint state by adjusting the second joint state based on the adversarial feedback detail” in step 103 may include steps 1031-1033.

1031: obtaining a refined joint state feature of the second joint state by performing a feature refinement on a joint state feature of the second joint state.

In this embodiment, after receiving the initially predicted second joint state, the generator may identify the joint state feature of the second joint state, and enhance some key features in the joint state feature of the second joint state to realize the feature refinement of the joint state feature of the second joint state, thereby obtaining the refined joint state feature of the second joint state.

1032: obtaining an enhanced joint state feature by adding the adversarial feedback detail to the refined joint state feature.

In this embodiment, before adding details to the refined joint state feature, the generator may also use a convolutional layer or a fully connected layer to map the refined joint state feature to a higher dimensional space and perform scaling, translation or other nonlinear transformations so as to generate more accurate joint position information.

In this embodiment, on the basis of the obtained refined joint state feature, the generator may realize feature enhancement by adding the adversarial feedback detail to the refined joint state feature so as to obtain the enhanced joint state feature.

1033: obtaining the adjusted joint state feature by performing feature adjustment on the enhanced joint state feature, and generating the third joint state based on the adjusted joint state feature.

In this embodiment, the generator may further perform feature adjustment on the enhanced joint state feature, that is, optimizing the state representation represented by the enhanced joint state feature to make it more in line with the actual distribution of the joint state. The adjusted joint state feature obtained after the feature adjustment may be understood as the feature of the joint state obtained based on the second joint state by performing quadratic prediction through the generator, that is, the third joint state predicted by the generator can be obtained by decoding through the enhanced joint state feature. Through the deep processing on the second joint state by the generator, the obtained third joint state can be more accurate, reliable and practical.

During the foregoing processing, noise will usually be introduced into the generator to enhance the diversity of generation, thereby obtaining richer joint state information through exploring.

As shown in FIG. 3A, the steps after step 103 are continued to explain.

104: controlling the robotic arm to swing to the third joint state in response to being at the second moment.

In this embodiment, the third joint state is the predicted state of the robotic arm of the robot at the second moment. Therefore, after obtaining the third joint state, the swing path (e.g., the rotational angle of the motor controlling the joint) of the robotic arm from the first moment to the second moment may be planned according to the state difference between the third joint state and the first joint state, then the robotic arm may be controlled to swing based on the planned swing path so that the robotic arm can be just in the third joint state when it is at the second moment.

Through the foregoing method, by obtaining the first joint state at the first moment and the environmental image collected at the first moment, the joint information of the first joint state and the environmental image is learned by determining the first joint feature between the two, thereby obtaining the second joint state by performing initial prediction on the joint state of the robotic arm at the second moment based on the first joint feature. Then, based on the adversarial feedback detail determined by adversarial learning, the second joint state is adjusted (i.e., performing quadratic prediction) to obtain a more accurate third joint state, thereby controlling the robotic arm of the robot to swing based on the third joint state. In this manner, the correlation between the environmental image and the first joint state is obtained through the first joint feature, and the state adjustment is further performed through the adversarial feedback detail to better generalize the data of the robot to different scenarios, thereby improving the accuracy of the predicted future joint state of the robotic arm of the robot.

As shown in FIG. 3A, “determining the adversarial feedback detail” in step 103 is continued to explain.

In some embodiments, the adversarial feedback detail in step 103 may be obtained when training the robot control model. FIG. 3D is a flow chart of determining an adversarial feedback detail according to an embodiment of the present disclosure. As shown in FIG. 3D, the adversarial feedback detail may be determined through steps 1034-1036.

1034: obtaining a first historical joint state of the robotic arm of the robot at a first historical moment, a second historical joint state of the robotic arm at a second historical moment, and a historical environment image collected by the robot for a historical environment at the first historical moment.

In this embodiment, the training samples for training the robot control model is prepared first. In which, the training samples may use the historical joint state and historical environment images of the robot within a historical period.

As an example, a set of training sample for training the robot control model may include: the first historical joint state of the robotic arm of the robot at the first historical moment, the second historical joint state at the second historical moment, and the historical environment image collected by the head camera 110 and the wrist camera 120 of the robot for the historical environment at the first historical moment. In which, the second historical moment is later than the first historical moment. During training, the robot control model may predict the joint state of the robotic arm at the second historical moment based on the first historical joint state and the historical environment image, and train the model based on the actual state (i.e., the second historical joint state) and the predicted joint state at the second historical moment.

1035: determining a second joint feature between the historical environment image and the first historical joint state, and obtaining a first predicted joint state by predicting a joint state of the robotic arm at the second historical moment based on the second joint feature.

FIG. 5 is a schematic diagram of the structure of a robot control model according to an embodiment of the present disclosure. As shown in FIG. 5, in this embodiment, the historical environment image and the first historical joint state are used as the inputs of the encoder in the VAE for performing the feature extraction on the historical environment image and the first historical joint state, respectively, through the encoder to obtain the historical image feature and the first historical joint state feature. Then, the historical image feature and the first historical joint state feature are mapped to the latent space to obtain a first historical mapping feature of the historical image feature in the latent space, a second historical mapping feature of the first historical joint state feature in the latent space, and an intrinsic correlation between the historical image feature and the first historical joint state feature. Based on the intrinsic correlation, the first historical mapping feature and the second historical mapping feature are fused to obtain the second joint feature between the historical environment image and the first historical joint state.

In this embodiment, the encoder uses the latent distribution between the first historical mapping feature and the second historical mapping feature to combine the two based on the intrinsic correlation so as to output the second joint feature.

As an example, the encoder may obtain the second joint feature based on an equation of:

$$z ∼ q ( z \vert x , y ) = N ( μ ( x , y ) , {σ}^{2} ( x , y ) ) ;$$

where, x represents the historical environment image, y represents the first historical joint state, z represents the second joint feature (i.e., the latent vector), z˜q(z|x,y) represents that the encoder compresses the historical environment image x and the first historical joint state y into a low-dimensional latent vector z, μ(x, y) represents calculating the mean between the feature of the historical environment image x and that of the first historical joint state y, and σ²(x, y) represents calculating the variance between the feature of the historical environment image x and that of the first historical joint state y.

In the foregoing equation, the process described by z˜q(z|x, y) is mainly to explore and represent the latent relationship between the historical environment image x and the first historical joint state y. By taking the historical environment image x and the first historical joint state y as the input, the encoder tries to find the intrinsic correlation between the two to compress into a low-dimensional space, thereby helping the model to understand the interaction between the two like how the position of the robotic arm takes effect or is affected by certain features in the image. The mean μ(x, y) represents a point in the latent space, which captures the central trend or typical feature of the input data (i.e., the historical environment image x and the first historical joint state y). In the VAE, the mean may be regarded as the central position of the latent variable, that is, it represents the most possible latent representation in the historical environment image and the first historical joint state. The variance σ²(x, y) represents the uncertainty or variation range of the latent variable, which describes the diversity of the input data or the dispersion degree of the latent representation. In this embodiment, large variance represents the encoder has a high uncertainty for a given input, which maybe because the input data itself has a large change, or because there are multiple possible representations in the latent space.

In sum, the encoder captures the statistical characteristics of the input data (i.e., the historical environment image x and the first historical joint state y) by calculating the mean and the variance, thereby expressing the complex relationship between them. The mean and the variance jointly define a probability distribution, and the latent vector z is sampled from this distribution for subsequent decoding and generation.

Then, the decoder of the VAE is responsible for mapping the features in the latent space back to the original space to generate the data similar to the original input.

As an example, the decoder receives the points (i.e., the latent vector z) from the latent space of the encoder, maps the points in the latent space back to the original space (i.e., the data space where the first historical joint state is located), then generates a probability distribution that can generate new data (i.e., the first predicted joint state).

As an example, the first predicted joint state may be obtained using an equation of:

$$\hat{y} = p ( y \vert z ) ;$$

where, ŷ represents the first predicted joint state, and p(y|z) represents the probability distribution determined based on the latent vector z and the first historical joint state y.

The steps after step 1035 are continued to explain.

1036: obtaining the adversarial feedback detail by performing adversarial learning based on the first predicted joint state and the second historical joint state.

In some embodiments, step 1036 may include: obtaining the first adversarial feedback detail by performing an adversarial learning based on the first predicted joint state and the second historical joint state; obtaining the first adjusted joint state by performing state adjustment on the first predicted joint state based on the first adversarial feedback detail; obtaining a second adversarial feedback detail by performing the adversarial learning based on the first adjusted joint state and the second historical joint state; and obtaining a second adjusted joint state by performing a state adjustment on the first adjusted joint state based on the second adversarial feedback detail, and determining the second adversarial feedback detail as the adversarial feedback detail in response to an error between the second adjusted joint state and the second historical joint state being less than a preset error.

In this embodiment, the adversarial learning of the GAN is a process of game between the generator and the discriminator. The goal of the game is that the generator learns to generate more real joint states, while the discriminator learns to distinguish the joint state generated by the generator from the real joint state. Specifically, the generator receives the first predicted joint state predicted by the decoder and tries to generate joint states with similar data distribution to the real data (i.e., the second historical joint state). The goal of training the generator is to deceive the discriminator so that it cannot distinguish the generated data from the real data. The discriminator receives the joint state generated by the generator and the real data (i.e., the second historical joint state), classifies the generated data and the real data, determines the score for classifying the second historical joint state as real and that for classifying the generated joint state as non-real. The goal of training the discriminator is to improve the ability to distinguish between the real data and the generated data.

In this embodiment, the training of the GAN is an iterative process which may include: initialize the parameters of the generator and the discriminator; under the condition of fixing the discriminator, obtain the first adversarial feedback detail based on the determination of the discriminator on the first predicted joint state and the second historical joint state to feedback to the generator; update the parameters of the generator based on the determination result of the discriminator so that the generator after updating the parameters performs state adjustment on the first predicted joint state based on the first adversarial feedback detail to obtain the first adjusted joint state for transmitting to the discriminator; under the condition of fixing the generator, the parameters of the discriminator are updated according to the generation result of the generator so that the discriminator performs truthfulness determination on the first adjusted joint state and the second historical joint state and obtains the second adversarial feedback detail according to the determination result; and fixing the discriminator again to update the parameters of the discriminator so that the generator performs state adjustment on the first adjusted joint state based on the second adversarial feedback detail to obtain the second adjusted joint state. The foregoing process is repeated until the error between the second adjusted joint state and the second historical joint state is lower than a preset error at which the second adversarial feedback detail is determined as the adversarial feedback details. In the iterative training, the adversarial between the generator and the discriminator reaches a dynamic balance, the joint state generated by the generator becomes more and more realistic, and the discriminator is also becoming more and more good at distinguishing the real data and the generated data.

In which, when training the GAN, the adversarial feedback detail refers to the specific information of the interaction between the generator and the discriminator during training. These feedback details are crucial to understanding the training behaviors of the adversarial generation network and improving model performance.

In some embodiments, “obtaining the first adversarial feedback detail by performing an adversarial learning based on the first predicted joint state and the second historical joint state” may include: obtaining a first category score of the first predicted joint state by classifying the first predicted joint state, and obtaining a second category score of the second historical joint stat by classifying the second historical joint state; determining a first loss of the adversarial learning based on the first category score and the second category score; and determining a state difference between the first predicted joint state and the second historical joint state based on the first loss, and obtaining the first adversarial feedback detail based on the state difference.

In this embodiment, the adversarial feedback detail refers to the specific information of the interaction between the generator and the discriminator during training. During training, the generator will receive the feedbacks from the discriminator to understand the similarity between the samples it generates and the real samples. The adversarial feedback detail generated by the discriminator usually depends on the loss.

As an example, after receiving the first predicted joint state, the discriminator will classify the first predicted joint state and the second historical joint state, that is, classify the first predicted joint state as non-real while classify the second historical joint state as real. The goal of the classification is to distinguish the real data and the generated data. When the discriminator performs classification, it will calculate the score of data classification. For example, the first category score of the first predicted joint state can be obtained by classifying the first predicted joint state, and the second category score of the second historical joint state can be obtained by classifying the second historical joint state.

The first loss of adversarial learning may be calculated using an equation of:

$${Γ}_{G A N} = E [ log D ( y ) ] + E [ log ( 1 - D ( {y}^{′} ) ) ] ;$$

where, D(y) represents the second category score, D(y′) represents the first category score, Γ_{GAN} represents the first loss, E[log D(y)] represents the expected output of the discriminator for the real data (i.e., the second historical joint state) that measures the predicted quality of the discriminator for the second historical joint state so that the larger the value of log D(y), the more reliable the classification of the second historical joint state, and E[log (1−D(y′))] represents the expected output of the discriminator for the generated data (i.e., first predicted joint state) that measures the accuracy of the determination of the discriminator for the first predicted joint state. Ideally, the discriminator should correctly classify the first predicted joint state as non-real, that is, the value of D(y′) is approximate to 0. Therefore, the larger the value of log (1−D(y′)), the more accurate the identification of the discriminator for the first predicted joint state.

Then, the first loss Γ_{GAN} of adversarial learning is determined through the sum of the first category score and the second category score. The state difference between the first predicted joint state and the second historical joint state is determined based on the first loss, and the first adversarial feedback detail is obtained based on the state difference, that is, the discriminator may obtain information such as parameters for gradient updates based on the first loss to take as the first adversarial feedback detail.

In some embodiments, “obtaining the first adversarial feedback detail by performing the adversarial learning based on the first predicted joint state and the second historical joint state” may include: determining a second loss and a third loss based on the first predicted joint state and the second historical joint state, where the second loss is for representing a similarity between the first predicted joint state and the second historical joint state, and the third loss is for representing a difference between a data space corresponding to the first predicted joint state and a data space corresponding to the second historical joint state; and performing the adversarial learning on the first predicted joint state and the second historical joint state based on the second loss and the third loss.

In this embodiment, after predicting the first predicted joint state, the VAE will further calculate a predicted loss which includes a second loss and a third loss. In which, the second loss is the reconstruction loss of the VAE, which is for representing the similarity between the first predicted joint state and the second historical joint state, and the third loss is the KL divergence loss of the VAE, which is for representing the degree of difference between the data space corresponding to the first predicted joint state and that corresponding to the second historical joint state.

As an example, the predicted loss may be calculated using an equation of:

$${Γ}_{V A E} = {E}_{q ( z \vert x , y )} [ log p ( y \vert z ) ] - {D}_{K L} ( q ( z \vert x , y ) ‖ p ( z ) ) ;$$

where, Γ_{VAE} represents the predicted loss, p(y z) represents the first predicted joint state, q(z|x, y) represents the latent distribution of the latent vector z, p (z) represents the priori distribution of the latent vector z, E_{q(z|x, y)}[log p(y|z)] represents the reconstruction loss, D_{KL}(q(z|x,y)∥p(z)) represents the KL divergence loss that is for measuring the difference between the latent distribution and the priori distribution so that the smaller the loss, the closer the learned latent distribution is to the set priori distribution.

In this embodiment, the parameters of the robot control model may be adjusted in a backward manner by combining the second loss, the third loss, and the first loss, that is, training the robot control model.

As an example, the fusion of the losses may be realized using an equation of:

$$Γ = {Γ}_{V A E} + λ {Γ}_{G A N} ;$$

where, Γ represents the total loss of the robot control model, Γ_{VAE} represents the predicted loss (i.e., the sum of the second loss and the third loss), Γ_{GAN} represents the first loss, λ represents a hyperparameter for weighting the two losses that is for balancing the generation quality and the reconstruction accuracy of the model.

In this embodiment, through the obtained total loss, the relevant parameters of the entire model may be adjusted in a reverse manner. Then, based on the foregoing training, other training samples may be used to iteratively train the robot control model again until the total loss meets a preset loss or the number of iterations reaches a preset number at which the iterative training is terminated to obtain the trained robot control model.

Through the foregoing method, the GAN and the VAE are combined in the robot control model so that the VAE can be used to generate the latent vector that meets the probability distribution, learn the correlation between the environmental image and the joint state to improve the accuracy of the prediction of the joint state of the future, and to learn the data distribution of the latent space to better generalize the model to new data, while the adversarial learning of the GAN can improve the accuracy of the generated joint states. By combining these two network structures, the robot can regenerate more accurate and robust control strategies for visual motion control tasks, and once the robot control model is trained, its inference will be very fast and suitable for the real-time control of robots and also suitable for the motion control tasks of the robot in various complex environments.

In one embodiment, the robot control system 100 may include the following modules:
an input module configured to process visual information data and joint state input of the robotic arm;
specifically, the head camera and the wrist camera of the robot may collect environmental images in real time for the robot to perceive the surrounding environmental state, and the sensor at the joint may collect the first joint state of the corresponding joint in real time to use as the state feedback for the motion control of the robot;
a model processing module, where the robot control model installed on the robot includes the VAE and the GAN;
specifically, the encoder of the VAE may receive the environment image x and the first joint state y that are inputted through the input module to encode as the latent vector z of the latent space, and the decoder may decode and generate initial robotic arm joint control instructions (i.e., the above-mentioned second joint state) based on the latent vector z; the generator of the GAN receives the initial robotic arm joint control instructions and generates more refined joint control instructions (i.e., the above-mentioned third joint state); and
a control module configured to control a corresponding joint of the robotic arm of the robot to perform a corresponding operation according to the generated joint control instruction (i.e., the above-mentioned third joint state).

In another embodiment, the training of the robot control model may include:
first, data preparation that collects a large number of training samples including the historical environment image and the corresponding historical joint state of the robot.
then, train the VAE by minimizing the reconstruction loss and the KL divergence loss, and learn the latent vector z between the input historical environment image and the historical joint state, where the calculation process of the latent vector z and that of the two losses can refer to the related embodiments in above.

Furthermore, regarding the training of the GAN, it has the goal of optimizing the joint state generated by the generator to make it closer to the real joint state, where the generator receives the joint control instruction initially generated by the decoder (i.e., the first predicted joint state) as the input to generate the refined joint control instructions (i.e., the second predicted joint state), the discriminator simultaneously receives the real joint state and the joint control instructions generated by the generator to outputs two classification values representing the probability of the real joint state and that of the joint control instructions generated by the generator, respectively, and calculate the first loss based on the equation for calculating the first loss in the related embodiment in above; and
finally, combine the reconstruction loss, the KL divergence loss, and the first loss to obtain the total loss, and adjust the parameters of the robot control model based on the total loss.

It should be noted that during the training, the parameters of the VAE and the GAN may be alternately optimized, so that the generator can generate more realistic joint control instructions.

Below, the exemplary structure of the robot control apparatus 455 that is implemented as a software module is to be explained. As shown in FIG. 2, in some embodiments, the software modules stored in the robot control apparatus 455 of the memory 450 may include:
an obtaining module 4551 configured to obtain a first joint state of a robotic arm of the robot at a first moment, and an environmental image collected by the robot at the first moment for a current environment;
a prediction module 4552 configured to determine a first joint feature between the environmental image and the first joint state, and obtain a second joint state by predicting a joint state of the robotic arm at a second moment based on the first joint feature;
an adjustment module 4553 configured to determine an adversarial feedback detail, and obtain a third joint state by adjusting the second joint state based on the adversarial feedback detail; and
a control module 4554 configured to control the robotic arm to swing to the third joint state in response to being at the second moment.

In some embodiments, the prediction module 4552 may be further configured to obtain an image feature by performing feature extraction on the environmental image, and obtain a joint state feature of the first joint state by performing feature extraction on the first joint state; map the image feature and the joint state feature to a latent space to obtain a first mapping feature of the image feature in the latent space, a second mapping feature of the joint state feature in the latent space, and an intrinsic correlation between the image feature and the joint state feature; and obtain the first joint feature between the environmental image and the first joint state by fusing the first mapping feature and the second mapping feature based on the intrinsic correlation.

In some embodiments, the prediction module 4552 may be further configured to obtain a third mapping feature of the first joint feature in an original space where the first joint state is located by mapping the first joint feature from the latent space to the original space; and obtain the second joint state by predicting the joint state of the robotic arm at the second moment based on the third mapping feature.

In some embodiments, the adjustment module 4553 may be further configured to obtain a refined joint state feature of the second joint state by performing a feature refinement on a joint state feature of the second joint state; obtain an enhanced joint state feature by adding the adversarial feedback detail to the refined joint state feature; and obtain the adjusted joint state feature by performing feature adjustment on the enhanced joint state feature, and generate the third joint state based on the adjusted joint state feature.

In some embodiments, the adjustment module 4553 may be further configured to obtain a first historical joint state of the robotic arm of the robot at a first historical moment, a second historical joint state of the robotic arm at a second historical moment, and a historical environment image collected by the robot for a historical environment at the first historical moment; determine a second joint feature between the historical environment image and the first historical joint state, and obtain a first predicted joint state by predicting a joint state of the robotic arm at the second historical moment based on the second joint feature; and obtain the adversarial feedback detail by performing adversarial learning based on the first predicted joint state and the second historical joint state.

In some embodiments, the adjustment module 4553 may be further configured to obtain the first adversarial feedback detail by performing an adversarial learning based on the first predicted joint state and the second historical joint state; obtain the first adjusted joint state by performing state adjustment on the first predicted joint state based on the first adversarial feedback detail; obtain a second adversarial feedback detail by performing the adversarial learning based on the first adjusted joint state and the second historical joint state; obtain a second adjusted joint state by performing a state adjustment on the first adjusted joint state based on the second adversarial feedback detail, and determine the second adversarial feedback detail as the adversarial feedback detail in response to an error between the second adjusted joint state and the second historical joint state being less than a preset error.

In some embodiments, the adjustment module 4553 may be further configured to obtain a first category score of the first predicted joint state by classifying the first predicted joint state, and obtain a second category score of the second historical joint stat by classifying the second historical joint state; determine a first loss of the adversarial learning based on the first category score and the second category score; determine a state difference between the first predicted joint state and the second historical joint state based on the first loss, and obtain the first adversarial feedback detail based on the state difference.

In some embodiments, the adjustment module 4553 may be further configured to determine a second loss and a third loss based on the first predicted joint state and the second historical joint state, where the second loss is for representing a similarity between the first predicted joint state and the second historical joint state, and the third loss is for representing a difference between a data space corresponding to the first predicted joint state and a data space corresponding to the second historical joint state; and perform the adversarial learning on the first predicted joint state and the second historical joint state based on the second loss and the third loss.

The embodiments of the present disclosure further provide a computer program product which includes computer program(s) or computer-executable instructions that are stored in a computer-readable storage medium. The processor of an electronic device reads and executes the computer-executable instructions from the computer-readable storage medium so that the electronic device executes the above-mentioned robot control method.

The embodiments of the present disclosure provide a computer-readable storage medium which stores computer-executable instructions or computer program(s). When the computer-executable instructions or the computer program(s) are executed by a processor, the processor is enabled to executable, for example, the robot control method shown in FIG. 3A.

In some embodiments, the computer-readable storage medium may be a storage such as RAM, ROM, flash memory, magnetic surface memory, optical disk, or CD-ROM, and may also be various equipment including one of the forgoing storages or any combination of them.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

As an example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

As an example, the computer-executable instructions may be deployed to execute on one electronic device, or on a plurality of electronic devices located at one location, or a plurality of electronic devices distributed across multiple locations and interconnected over a communication network.

The foregoing are only the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for controlling a robot having a robotic arm, comprising:
obtaining a first joint state of the robotic arm of the robot at a first moment, and an environmental image collected by the robot at the first moment for a current environment;
determining a first joint feature between the environmental image and the first joint state, and obtaining a second joint state by predicting a joint state of the robotic arm at a second moment based on the first joint feature;
determining an adversarial feedback detail, and obtaining a third joint state by adjusting the second joint state based on the adversarial feedback detail; and
controlling the robotic arm to swing to the third joint state in response to being at the second moment.

2. The method of claim 1, wherein determining the first joint feature between the environmental image and the first joint state comprises:
obtaining an image feature by performing feature extraction on the environmental image, and obtaining a joint state feature of the first joint state by performing feature extraction on the first joint state;
mapping the image feature and the joint state feature to a latent space to obtain a first mapping feature of the image feature in the latent space, a second mapping feature of the joint state feature in the latent space, and an intrinsic correlation between the image feature and the joint state feature; and
obtaining the first joint feature between the environmental image and the first joint state by fusing the first mapping feature and the second mapping feature based on the intrinsic correlation.

3. The method of claim 2, wherein obtaining a second joint state by predicting a joint state of the robotic arm at a second moment based on the first joint feature comprises:
obtaining a third mapping feature of the first joint feature in an original space where the first joint state is located by mapping the first joint feature from the latent space to the original space; and
obtaining the second joint state by predicting the joint state of the robotic arm at the second moment based on the third mapping feature.

4. The method of claim 1, wherein obtaining the third joint state by adjusting the second joint state based on the adversarial feedback detail comprises:
obtaining a refined joint state feature of the second joint state by performing a feature refinement on a joint state feature of the second joint state;
obtaining an enhanced joint state feature by adding the adversarial feedback detail to the refined joint state feature; and
obtaining the adjusted joint state feature by performing feature adjustment on the enhanced joint state feature, and generating the third joint state based on the adjusted joint state feature.

5. The method of claim 1, wherein determining the adversarial feedback detail comprises:
obtaining a first historical joint state of the robotic arm of the robot at a first historical moment, a second historical joint state of the robotic arm at a second historical moment, and a historical environment image collected by the robot for a historical environment at the first historical moment;
determining a second joint feature between the historical environment image and the first historical joint state, and obtaining a first predicted joint state by predicting a joint state of the robotic arm at the second historical moment based on the second joint feature; and
obtaining the adversarial feedback detail by performing adversarial learning based on the first predicted joint state and the second historical joint state.

6. The method of claim 5, wherein obtaining the adversarial feedback detail by performing adversarial learning based on the first predicted joint state and the second historical joint state comprises:
obtaining the first adversarial feedback detail by performing an adversarial learning based on the first predicted joint state and the second historical joint state;
obtaining the first adjusted joint state by performing state adjustment on the first predicted joint state based on the first adversarial feedback detail;
obtaining a second adversarial feedback detail by performing the adversarial learning based on the first adjusted joint state and the second historical joint state; and
obtaining a second adjusted joint state by performing a state adjustment on the first adjusted joint state based on the second adversarial feedback detail, and determining the second adversarial feedback detail as the adversarial feedback detail in response to an error between the second adjusted joint state and the second historical joint state being less than a preset error.

7. The method of claim 6, wherein obtaining the first adversarial feedback detail by performing the adversarial learning based on the first predicted joint state and the second historical joint state comprises:
obtaining a first category score of the first predicted joint state by classifying the first predicted joint state, and obtaining a second category score of the second historical joint stat by classifying the second historical joint state;
determining a first loss of the adversarial learning based on the first category score and the second category score; and
determining a state difference between the first predicted joint state and the second historical joint state based on the first loss, and obtaining the first adversarial feedback detail based on the state difference.

8. The method of claim 6, wherein performing the adversarial learning based on the first predicted joint state and the second historical joint state comprises:
determining a second loss and a third loss based on the first predicted joint state and the second historical joint state, wherein the second loss is for representing a similarity between the first predicted joint state and the second historical joint state, and the third loss is for representing a difference between a data space corresponding to the first predicted joint state and a data space corresponding to the second historical joint state; and
performing the adversarial learning on the first predicted joint state and the second historical joint state based on the second loss and the third loss.

9. A robot, comprising:
a robotic arm;
a processor;
a memory coupled to the processor; and
one or more computer programs stored in the memory and executable on the processor;
wherein, the one or more computer programs comprise:
instructions for obtaining a first joint state of the robotic arm of the robot at a first moment, and an environmental image collected by the robot at the first moment for a current environment;
instructions for determining a first joint feature between the environmental image and the first joint state, and obtaining a second joint state by predicting a joint state of the robotic arm at a second moment based on the first joint feature;
instructions for determining an adversarial feedback detail, and obtaining a third joint state by adjusting the second joint state based on the adversarial feedback detail; and
instructions for controlling the robotic arm to swing to the third joint state in response to being at the second moment.

10. The robot of claim 9, wherein the instructions for determining the first joint feature between the environmental image and the first joint state comprise:
instructions for obtaining an image feature by performing feature extraction on the environmental image, and obtaining a joint state feature of the first joint state by performing feature extraction on the first joint state;
instructions for mapping the image feature and the joint state feature to a latent space to obtain a first mapping feature of the image feature in the latent space, a second mapping feature of the joint state feature in the latent space, and an intrinsic correlation between the image feature and the joint state feature; and
instructions for obtaining the first joint feature between the environmental image and the first joint state by fusing the first mapping feature and the second mapping feature based on the intrinsic correlation.

11. The robot of claim 10, wherein the instructions for obtaining a second joint state by predicting a joint state of the robotic arm at a second moment based on the first joint feature comprise:
instructions for obtaining a third mapping feature of the first joint feature in an original space where the first joint state is located by mapping the first joint feature from the latent space to the original space; and
instructions for obtaining the second joint state by predicting the joint state of the robotic arm at the second moment based on the third mapping feature.

12. The robot of claim 9, wherein the instructions for obtaining the third joint state by adjusting the second joint state based on the adversarial feedback detail comprise:
instructions for obtaining a refined joint state feature of the second joint state by performing a feature refinement on a joint state feature of the second joint state;
instructions for obtaining an enhanced joint state feature by adding the adversarial feedback detail to the refined joint state feature; and
instructions for obtaining the adjusted joint state feature by performing feature adjustment on the enhanced joint state feature, and generating the third joint state based on the adjusted joint state feature.

13. The robot of claim 9, wherein the instructions for determining the adversarial feedback detail comprise:
instructions for obtaining a first historical joint state of the robotic arm of the robot at a first historical moment, a second historical joint state of the robotic arm at a second historical moment, and a historical environment image collected by the robot for a historical environment at the first historical moment;
instructions for determining a second joint feature between the historical environment image and the first historical joint state, and obtaining a first predicted joint state by predicting a joint state of the robotic arm at the second historical moment based on the second joint feature; and
instructions for obtaining the adversarial feedback detail by performing adversarial learning based on the first predicted joint state and the second historical joint state.

14. The robot of claim 13, wherein the instructions for obtaining the adversarial feedback detail by performing adversarial learning based on the first predicted joint state and the second historical joint state comprise:
instructions for obtaining the first adversarial feedback detail by performing an adversarial learning based on the first predicted joint state and the second historical joint state;
instructions for obtaining the first adjusted joint state by performing state adjustment on the first predicted joint state based on the first adversarial feedback detail;
instructions for obtaining a second adversarial feedback detail by performing the adversarial learning based on the first adjusted joint state and the second historical joint state; and
instructions for obtaining a second adjusted joint state by performing a state adjustment on the first adjusted joint state based on the second adversarial feedback detail, and determining the second adversarial feedback detail as the adversarial feedback detail in response to an error between the second adjusted joint state and the second historical joint state being less than a preset error.

15. The robot of claim 14, wherein the instructions for obtaining the first adversarial feedback detail by performing the adversarial learning based on the first predicted joint state and the second historical joint state comprise:
instructions for obtaining a first category score of the first predicted joint state by classifying the first predicted joint state, and obtaining a second category score of the second historical joint stat by classifying the second historical joint state;
instructions for determining a first loss of the adversarial learning based on the first category score and the second category score; and
instructions for determining a state difference between the first predicted joint state and the second historical joint state based on the first loss, and obtaining the first adversarial feedback detail based on the state difference.

16. The robot of claim 14, wherein the instructions for performing the adversarial learning based on the first predicted joint state and the second historical joint state comprise:
instructions for determining a second loss and a third loss based on the first predicted joint state and the second historical joint state, wherein the second loss is for representing a similarity between the first predicted joint state and the second historical joint state, and the third loss is for representing a difference between a data space corresponding to the first predicted joint state and a data space corresponding to the second historical joint state; and
instructions for performing the adversarial learning on the first predicted joint state and the second historical joint state based on the second loss and the third loss.

17. A non-transitory computer-readable storage medium for storing one or more computer programs, wherein the one or more computer programs comprise:
instructions for obtaining a first joint state of a robotic arm of a robot at a first moment, and an environmental image collected by the robot at the first moment for a current environment;
instructions for determining a first joint feature between the environmental image and the first joint state, and obtaining a second joint state by predicting a joint state of the robotic arm at a second moment based on the first joint feature;
instructions for determining an adversarial feedback detail, and obtaining a third joint state by adjusting the second joint state based on the adversarial feedback detail; and
instructions for controlling the robotic arm to swing to the third joint state in response to being at the second moment.

18. The storage medium of claim 17, wherein the instructions for determining the first joint feature between the environmental image and the first joint state comprise:
instructions for obtaining an image feature by performing feature extraction on the environmental image, and obtaining a joint state feature of the first joint state by performing feature extraction on the first joint state;
instructions for mapping the image feature and the joint state feature to a latent space to obtain a first mapping feature of the image feature in the latent space, a second mapping feature of the joint state feature in the latent space, and an intrinsic correlation between the image feature and the joint state feature; and
instructions for obtaining the first joint feature between the environmental image and the first joint state by fusing the first mapping feature and the second mapping feature based on the intrinsic correlation.

19. The storage medium of claim 18, wherein the instructions for obtaining a second joint state by predicting a joint state of the robotic arm at a second moment based on the first joint feature comprise:
instructions for obtaining a third mapping feature of the first joint feature in an original space where the first joint state is located by mapping the first joint feature from the latent space to the original space; and
instructions for obtaining the second joint state by predicting the joint state of the robotic arm at the second moment based on the third mapping feature.

20. The storage medium of claim 17, wherein the instructions for obtaining the third joint state by adjusting the second joint state based on the adversarial feedback detail comprise:
instructions for obtaining a refined joint state feature of the second joint state by performing a feature refinement on a joint state feature of the second joint state;
instructions for obtaining an enhanced joint state feature by adding the adversarial feedback detail to the refined joint state feature; and
instructions for obtaining the adjusted joint state feature by performing feature adjustment on the enhanced joint state feature, and generating the third joint state based on the adjusted joint state feature.
